(19) United States
(12) Patent Application Publication
(10) Pub. No.: US 2023/0356578 A1
(43) Pub. Date: Nov. 9, 2023

(54) DETACHABLE, MIRROR-PROTECTING DEVICE FOR VEHICLES

(71) Applicant: Manuel Alejandro Sanchez Velez, Arlington, VA (US)

(72) Inventor: Manuel Alejandro Sanchez Velez, Arlington, VA (US)

(21) Appl. No.: 18/195,371

(22) Filed: May 9, 2023

Related U.S. Application Data
(60) Provisional application No. 63/339,924, filed on May 9, 2022.

(51) Int. Cl. B60J 11/06

(52) U.S. Cl. CPC B60J 11/06

(57) ABSTRACT

The present invention is a detachable device for protecting exterior mirrors of vehicles. As a non-limiting embodiment, the detachable device includes a housing and an impact-resistant, impact-absorbing and/or impact-deflecting material. The detachable device may also include a housing securing element, a proximity sensor, and/or a signaling light or indicator. As a non-limiting example, the housing preferably includes a front wall, at least one side wall, a top wall, an exterior surface, an interior surface, and a chamber for retaining the impact-resistant, impact-absorbing and/or impact-deflecting material. The housing may also include a bottom wall. Preferably, the housing is dimensioned and configured for being as large as or larger than the corresponding exterior mirror of a vehicle so as to be able to provide sufficient protection for the corresponding exterior mirror when the housing surrounds the mirror or is positioned a certain distance in front (or a corresponding direction) of the mirror.

### CROSS-REFERENCE TO RELATED APPLICATIONS

The present application claims the priority benefit of U.S. Provisional Patent Application Ser. No. 63/339,924, filed on May 9, 2022 and titled “DETACHABLE, MIRROR-PROTECTING DEVICE FOR VEHICLES,” which is incorporated herein by reference in its entirety.

### BACKGROUND OF THE INVENTION

### Field of the Invention

The present invention generally relates to mirror-protecting devices, apparatuses and systems for vehicles. More specifically, the present invention is a detachable device for protecting exterior mirrors, such as, but not limited to, exterior rear view mirrors, of vehicles.

### Description of the Related Art

Mirror-protecting devices, apparatuses and systems for vehicles are known in the art.

The present invention overcomes one or more of the shortcomings of other mirror-protecting devices, apparatuses and systems for vehicles. The Applicant is unaware of inventions or patent documents, taken either singly or in combination, which are seen to describe the present invention as claimed.

An advantage of the detachable, mirror-protecting device of the present invention is that it is capable of protecting the exterior mirrors of vehicles in preferably low-impact collisions and other circumstances.

Another advantage of the detachable, mirror-protecting device of the present invention is that it requires no, minimal, or only minor modification of the exterior mirrors of vehicles.

A further advantage of the detachable, mirror-protecting device of the present invention is that it can be quickly attached to and detached from exterior mirrors and/or housing securing area(s) in proximity to the exterior mirrors (such as, but not limited, a bezel, a fender, a door, or a panel) of vehicles.

An additional advantage of the detachable, mirror-protecting device of the present invention is that it can provide an inexpensive or lower cost means as compared to having to replace a more expensive exterior mirror if no protection was provided to the mirror.

### SUMMARY OF THE INVENTION

The present invention is a detachable device for protecting exterior mirrors, such as, but not limited to, exterior rear view mirrors, of vehicles. As a non-limiting embodiment, the detachable, mirror-protecting device includes a housing and an impact-resistant, impact-absorbing and/or impact-deflecting material. The detachable, mirror-protecting device may also include a housing securing element, a proximity sensor, and/or a signaling light or indicator.

As a non-limiting example, the housing preferably comprises a front wall, at least one side wall (preferably at least an outer side wall, and more preferably a pair of side walls), a top wall, an exterior surface, an interior surface, and a chamber for retaining the impact-resistant, impact-absorbing and/or impact-deflecting material. The housing may also comprise a bottom wall. Preferably, the housing is dimensioned and configured for being as large as or larger than the corresponding exterior mirror of a vehicle so as to be able to provide sufficient protection for the corresponding exterior mirror when the housing surrounds the mirror or is positioned a certain distance in front (or a corresponding direction) of the mirror. As another non-limiting example, the housing may further comprise a rear wall that may be attachable during vehicle or mirror non-use (and detachable during vehicle or mirror use), retractable, or see-through such that the mirror is accessible for the driver during vehicle use.

As a non-limiting example, the impact-resistant, impact-absorbing and/or impact-deflecting material is preferably an impact-resistant, impact-absorbing and/or impact-deflecting layer(s) of material that is preferably disposed or positioned fully, substantially or partially within the chamber of the housing and preferably secured to, about, adjacent, or proximate the interior surface of the housing. As another non-limiting example, the impact-resistant, impact-absorbing and/or impact-deflecting material is preferably an impact-resistant, impact-absorbing and/or impact-deflecting layer(s) of material that is disposed or positioned outside the housing and between the housing and corresponding exterior mirror.

Preferably, the impact-resistant, impact-absorbing and/or impact-deflecting material is sufficiently effective in protecting exterior mirrors of vehicles against low-impact collisions and other circumstances, such as, but not limited to, dings, bumps, etc. from objects and other vehicles.

### BRIEF DESCRIPTION OF THE DRAWINGS

FIG. 1 is an environmental, perspective view of an embodiment of a detachable, mirror-protecting device according to the present invention;

FIG. 2 is an environmental, side view of the detachable, mirror-protecting device of FIG. 1;

FIG. 3 is an environmental, front view of the detachable, mirror-protecting device of FIG. 1;

FIG. 4 is an environmental, perspective view of another embodiment of a detachable, mirror-protecting device according to the present invention;

FIG. 5 is an environmental, side view of the detachable, mirror-protecting device of FIG. 4;

FIG. 6 is an environmental, front view of the detachable, mirror-protecting device of FIG. 4;

FIG. 7 is an environmental, perspective view of a further embodiment of a detachable, mirror-protecting device according to the present invention;

FIG. 8 is an environmental, side view of the detachable, mirror-protecting device of FIG. 7;

FIG. 9 is an environmental, front view of the detachable, mirror-protecting device of FIG. 7;

FIG. 10 is a perspective, left side view of an additional embodiment of a detachable, mirror-protecting device according to the present invention;

FIG. 11 is a cross-sectional view of the detachable, mirror-protecting device of FIG. 10;

FIG. 12 is an environmental, perspective, front, left side view of a further embodiment of a detachable, mirror-protecting device according to the present invention; and

FIG. 13 is a rear view of the detachable, mirror-protecting device of FIG. 12.

It should be understood that the above-attached figures are not intended to limit the scope of the present invention in any way.

### DETAILED DESCRIPTION OF THE PREFERRED EMBODIMENTS

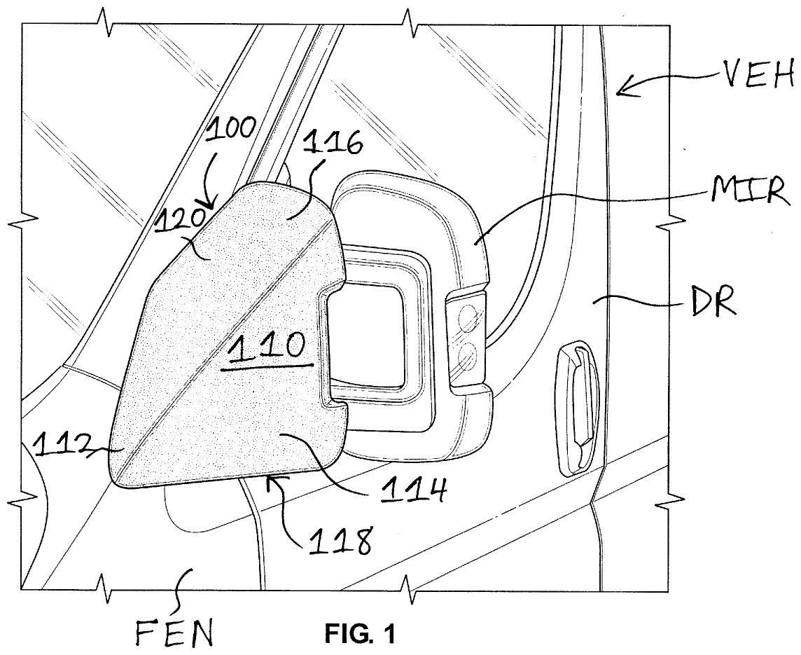

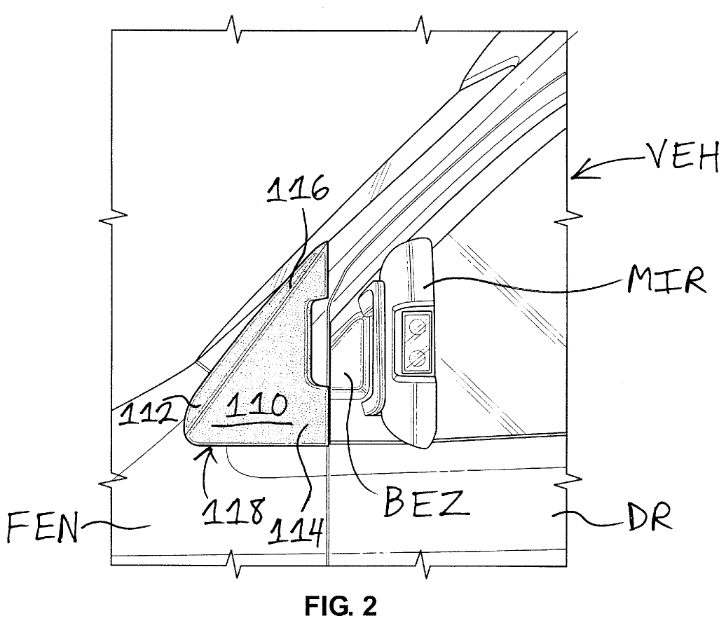

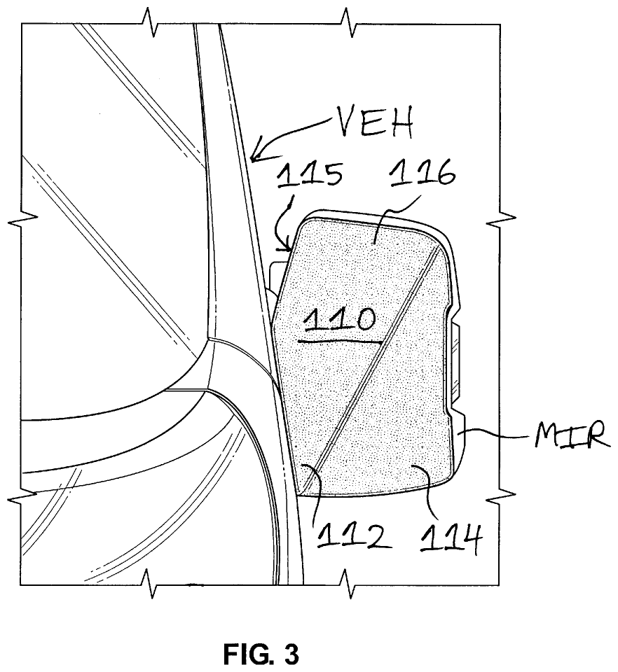

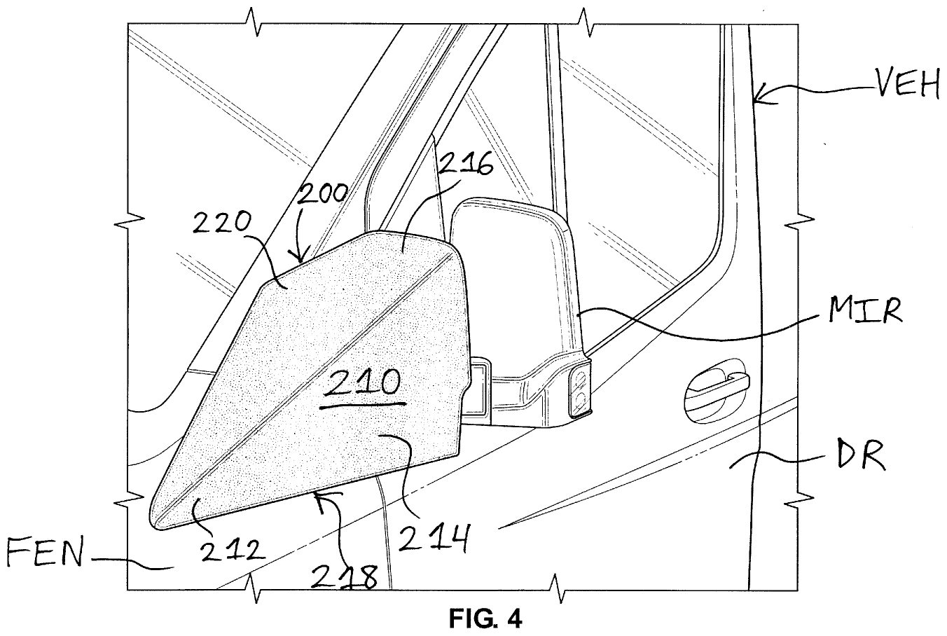

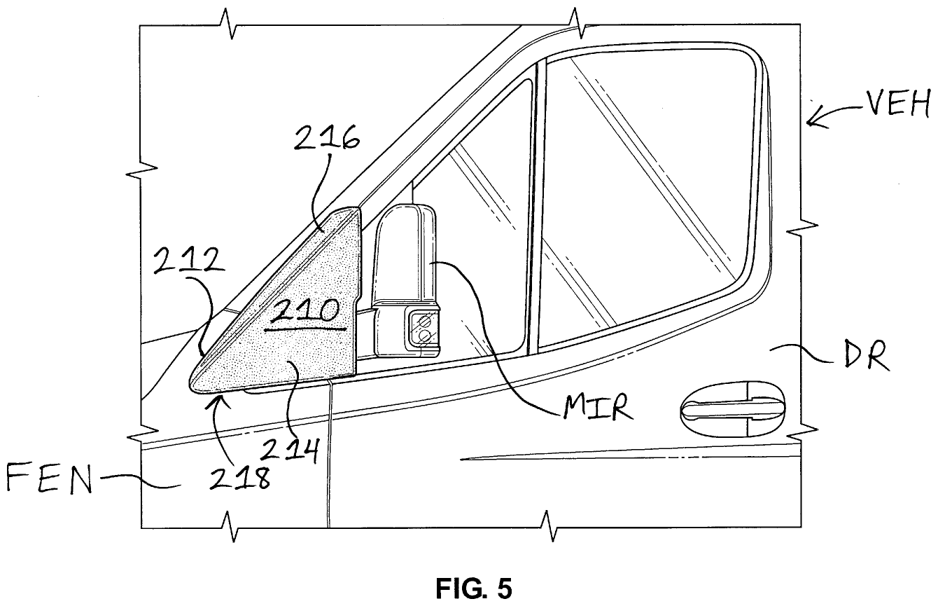

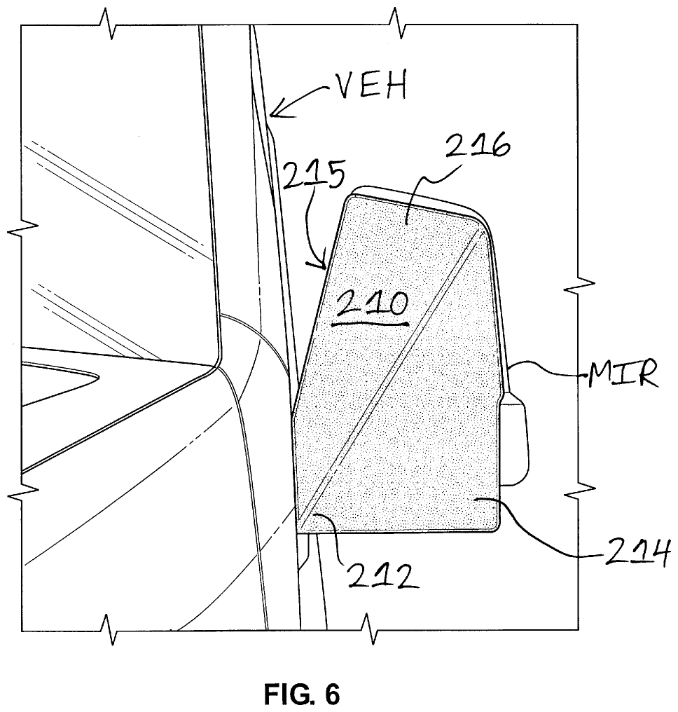

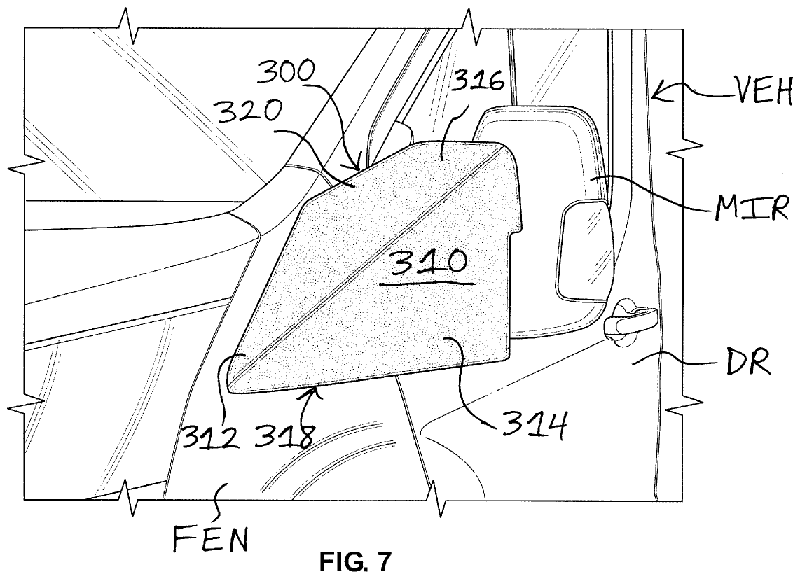

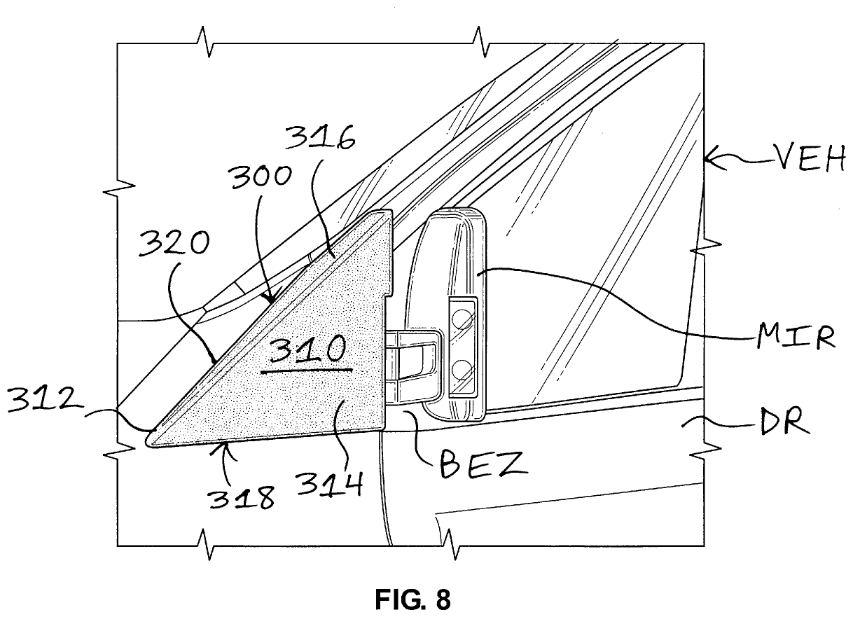

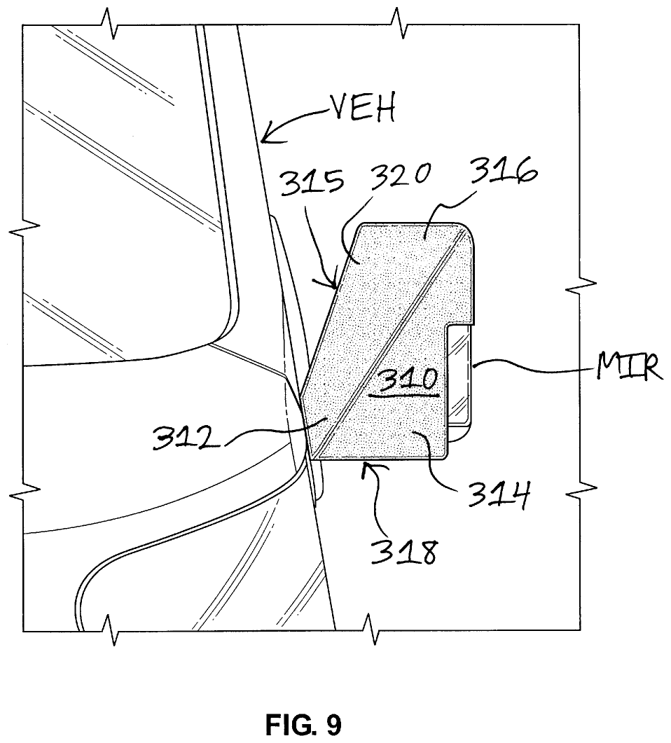

Referring to FIGS. 1-13, the present invention is a detachable device 100,200,300,400,500 (preferably substantially similar to one another) for protecting exterior mirrors MIR, such as, but not limited to, driver side and/or passenger side exterior rear view mirrors, of vehicles VEH, such as, but not limited to, a delivery van (such as, but not limited to, a Dodge ProMaster, a Mercedes-Benz Sprinter, or a Ford Transit), a transport van, a delivery truck, a transport truck, an automobile, or an SUV. As non-limiting embodiments, the detachable, mirror-protecting device 100,200,300,400,500 includes a housing 110,210,310,410,510 and an impact-resistant, impact-absorbing and/or impact-deflecting material 480,580 (not shown for device 100,200,300). The detachable, mirror-protecting device 100,200,300,400,500 may further include a housing securing element 490 (not shown for device 100,200,300,500) for securing the housing 110,210,310,410,510 to the exterior mirror MIR and/or housing securing area(s) (such as, but not limited, a bezel BEZ, a fender FEN, a door DR, or a panel) in proximity to the exterior mirror MIR of the vehicle VEH. In addition, the detachable, mirror-protecting device 100,200,300,400 may further include a proximity sensor (not shown) and/or a signaling light or indicator (not shown). With regard to the detachable, mirror-protecting device 500, it further includes a device attachment extension 600.

As non-limiting examples, the housing 110,210,310,410 preferably comprises a front wall 112,212,312,412, at least one side wall (preferably at least an outer side wall 114,214,314,414, and preferably a pair of side walls 114,115,214,215, 314,315,414,415), a top wall 116,216,316,416, a bottom wall 118,218,318,418, an exterior surface 120,220,320,420, an interior surface 422 (not shown for device 100,200,300), and a cavity or chamber 424 (not shown for device 100,200,300). Preferably, the housing 110,210,310, 410 is dimensioned and configured for being as large as or larger than a substantial portion (excluding the glass) of an exterior mirror MIR of the vehicle VEH so as to be able to provide adequate or sufficient protection for the exterior mirror MIR. The housing 110,210,310,410 may be made or manufactured of the following material(s), such as, but not limited to, plastic, rubber, steel, stainless steel, metal, any impact-resistant material, any impact-absorbing material, any impact-deflecting material, and/or any combination thereof, or any material or any combination of materials known to one of ordinary skill in the art. Preferably, the housing 110,210,310,410 is made or manufactured of a durable material, such as, but not limited to, plastic (such as, but not limited to, hard plastic), rubber, and/or any combination thereof. As a non-limiting example, the housing 110,210,310,410 is configured or is made or manufactured in a similar shape, preferably substantially similar or exactly the same shape, as the exterior mirror MIR of the vehicle VEH so as to keep the appearance of the exterior mirror MIR as close as possible to the exterior mirror's non-protected appearance. As another non-limiting example and as shown in FIGS. 1-11, the housing 110,210,310,410 is configured or is made or manufactured in an aerodynamic shape, wherein the housing 110,210,310,410 increases aerodynamic effects for the corresponding exterior mirror MIR.

Preferably, the front wall 112,212,312,412 or exterior of the front wall 112,212,312,412 is made or manufactured of a strong plastic material that can withstand different weather conditions and impacts made from zero to about forty miles per hour.

As non-limiting examples, the housing 110,210,310,410 may further comprise a rear wall (not shown for device 100,200,300,400) that may be already present, attached during vehicle non-use (and detached during vehicle use), retractable, or see-through (particularly when the exterior mirror MIR is positioned within the housing 110,210,310,410) such that the exterior mirror MIR is accessible for the driver during vehicle use.

The housing 110,210,310,410 may be made or manufactured of various shapes, configurations, and sizes to be functional with various exterior mirrors MIR of variuous vehicles VEH. As a non-limiting example, the housing 110,210, 310,410 is secured to a vehicle VEH and positioned about one inch to about twelve inches, more preferably about three inches to about seven inches, in front (from a front to rear vehicle perspective) of the exterior mirror MIR of the vehicle VEH.

The impact-resistant, impact-absorbing and/or impact-deflecting material 480 (not shown for device 100,200,300) is preferably an impact-resistant, impact-absorbing and/or impact-deflecting layer(s) of material disposed or positioned between the interior surface 422 (not shown for device 100,200,300) of the housing 110,210,310,410 and the exterior mirror MIR of the vehicle VEH when the device 100,200,300,400 is secured to, about, adjacent, proximate, or in front of the exterior mirror MIR. Preferably, the impact-resistant, impact-absorbing and/or impact-deflecting material 480 surrounds a substantial portion (excluding the glass) of or is positioned an effective distance in front of the exterior mirror MIR to provide the exterior mirror MIR with substantial protection against low-impact collisions and other circumstances, such as, but not limited to, dings, bumps, etc. from objects (other vehicle doors during closing and opening, grocery carts, etc.), passerby, and other vehicles. The impact-resistant, impact-absorbing and/or impact-deflecting material 480 may be made or manufactured of the following material(s), such as, but not limited to, foam, rubber, plastic (such as, but not limited to, soft plastic), or any combination thereof. Preferably, the impact-resistant, impact-absorbing and/or impact-deflecting material 480 is an impact-resistant, impact-absorbing and/or impact-deflecting foam, such as, but not limited to, resilient foam or memory foam, that may be one layer having a predetermined thickness or multiple layers wherein each layer has a predetermined thickness. One non-limiting example of a foam is an impact-resistant, impact-absorbing and/or impact-deflecting foam from the Sorbothane company. Preferably, the impact-resistant, impact-absorbing and/or impact-deflecting material 480 also controls or reduces vibrations and noise when the device 100,200,300,400 is secured with the exterior mirror MIR and/or housing securing area(s) in proximity to the exterior mirror MIR of the vehicle VEH.

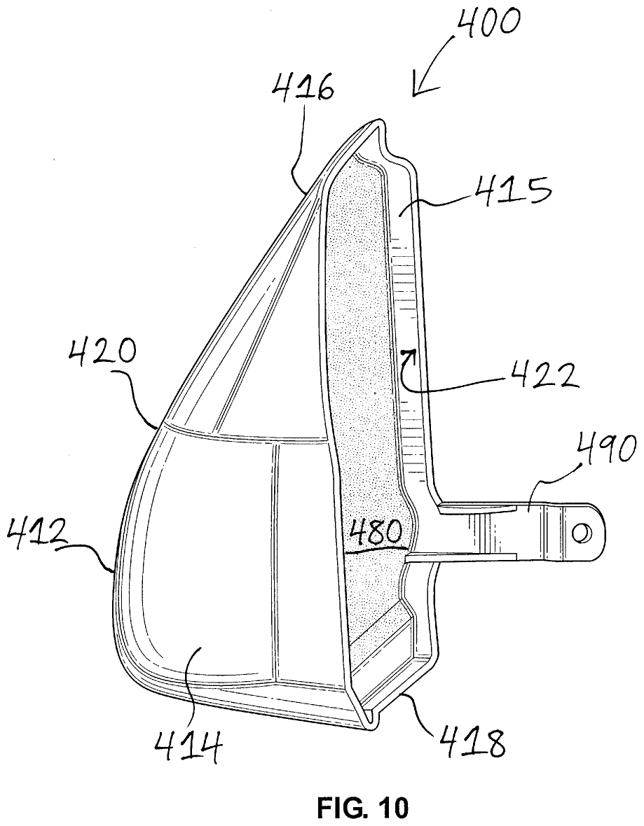

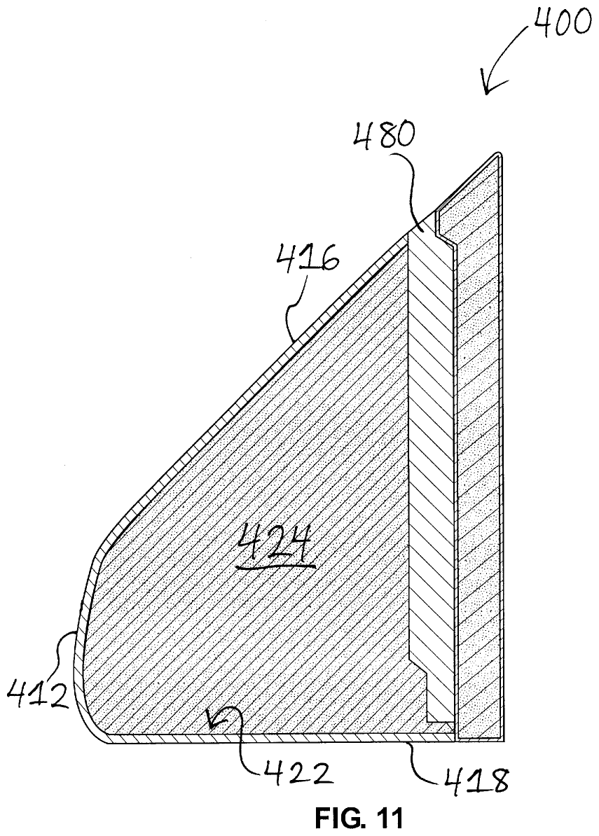

The housing securing element 490 (not shown for device 100,200,300) may be any securing element known to one of ordinary skill in the art that is able to detachably secure the housing 110,210,310,410 to the exterior mirror MIR and/or housing securing area(s) (such as, but not limited, a bezel BEZ, a fender FEN, a door DR, or a panel) in proximity to the exterior mirror MIR of the vehicle VEH. As non-limiting examples, the housing securing element 490 is/are clips and rivets (shown in FIGS. 10 and 11).

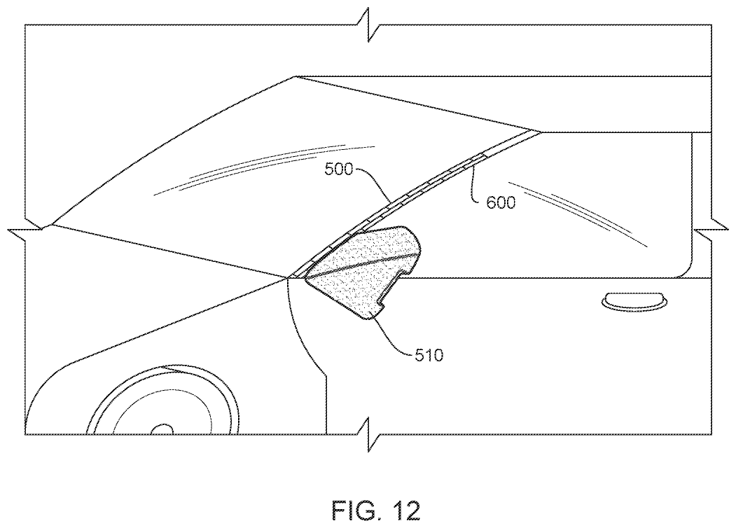

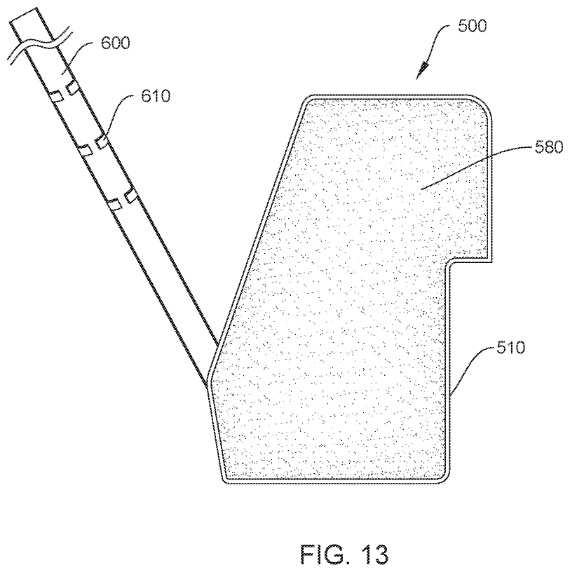

Referring to FIGS. 12 and 13, the detachable, mirror-protecting device 500 is further includes a device attachment extension 600, which is preferably focused on any other personal vehicle, such as, but not limited to, personal automobiles. The shapes and sizes of the device 500 and extension 600 will vary by the specifications of the vehicle.

As one non-limiting example, the extension 600 is a 2′ to 4′ long and 1″ to 2″ wide part that contains clips on the inside. The extension 600 may be secured or attached to the frame of the vehicle door. The housing of the device 500 will contain foam in the interior and plastic on the outside (material that can sustain any weather). The size and shape of the device 500 will depend on the type of vehicle.

The proximity sensor (not shown) may be any proximity sensor known to one of ordinary skill in the art that is able to sense and then communicate to or alert the driver as the vehicle VEH is approaching an object or vice versa.

The signaling light or indicator (not shown) may be any signaling light or indicator known to one of ordinary skill in the art that is able to provide a signal or alert to vehicle(s) behind and also preferably to the corresponding side and/or front of the driver's vehicle VEH of a forthcoming and/or currect lane change or vehicle turn by the driver.

It is to be understood that the present invention is not limited to the embodiments described above or as shown in the attached figures, but encompasses any and all embodiments within the spirit of the invention.

1. A detachable, mirror-protecting device comprising:
a housing; and
an impact-resistant, impact-absorbing and/or impact-deflecting material positioned within said housing.

2. A detachable, mirror-protecting device comprising:
a housing;
an impact-resistant, impact-absorbing and/or impact-deflecting material positioned within said housing; and
a vehicle attachment extension for being secured to a vehicle.
